(19) United States
(12) Patent Application Publication
(10) Pub. No.: US 2018/0345539 A1
(43) Pub. Date: Dec. 6, 2018

(54) METHOD FOR PRODUCING FRP PRECURSOR AND DEVICE FOR PRODUCING SAME

(71) Applicant: HITACHI CHEMICAL COMPANY, LTD., Tokyo (JP)

(72) Inventors: Yuji TOSAKA, Chikusei-shi, Ibaraki (JP); Yoshinori SATOH, Hitachi-shi, Ibaraki (JP); Takeshi SAITOH, Sakuragawa-shi, Ibaraki (JP)

(21) Appl. No.: 15/570,973

(22) PCT Filed: Apr. 27, 2016
(86) PCT No.: PCT/JP2016/063264

§ 371 Date: Oct. 31, 2017

(30) Foreign Application Priority Data
May 1, 2015 (JP) 2015-094383

(51) Int. Cl. B29B 15/12; B29B 11/04; B29B 11/12; B29D 7/01

(52) U.S. Cl. CPC B29B 15/12; B29B 11/04; B29K 2101/10; B29D 7/01; B29B 11/12

(57) ABSTRACT

Provided are a method for producing an FRP precursor and a device for producing an FRP precursor, wherein the said FRP precursor is excellent in impregnability of a thermosetting resin as well as in heat resistance of the FRP precursor to be obtained. The method for producing the FRP precursor, wherein each of one pair of thermosetting resin films 54 are adhered to each of both surfaces 40a and 40b of an aggregate 40 in a form of a sheet, comprises: an attaching process to attach an organic solvent 13a to the both surfaces 40a and 40b of the aggregate 40; a film press-adhering process wherein under a normal pressure, each of the aggregate-side film surfaces 54a of the pair of the films 54 and 54 is press-adhered to each of the both surfaces 40a and 40b of the soaked aggregate 40 to obtain the FRP precursor 60; and an attached amount adjusting process to adjust amount of the organic solvent 13a that is attached to the soaked aggregate 40. The attaching process comprises soaking of the aggregate 40 into the vessel 13b.

### TECHNICAL FIELD

The present invention relates to an FRP precursor and a device for producing the same.

### BACKGROUND ART

FRP (Fiber Reinforced Plastics) is a composite material using an aggregate with a high modulus, such as fibers, wherein the aggregate is incorporated into a mother material (matrix) such as a plastic material in order to enhance the strength thereof. Therefore, FRP is a composite material which is cheap, light, and excellent in durability because this utilizes its weatherability, lightness, and resistances to heat and chemicals.

By utilizing these characteristics, FRP is used in a wide field. For example, because FRP can be molded and has high strength, it is used as structural materials of housing equipment, marine vessels, vehicles, airplanes, etc. In addition, because of its electric non-conductance, FRP is used also in electric devices as well as in the field of electronic parts such as a printed circuit board.

Illustrative example of the FRP production method includes an RTM (Resin Transfer Molding) method wherein a resin is charged into a matched mold having an aggregate spread therein, a Hand Lay-up (HLU) method or a spray-up method wherein with defoaming a resin the resin is laminated in a multiple fashion onto a spread aggregate, and an SMC (Sheet Molding Compound) press method wherein an aggregate and a resin are pre-mixed and made to a form of a sheet, and then this is press-molded in a mold.

When FRP is used for a printed circuit board, the thickness of FRP for the printed circuit board is required to be thinner than the thickness of the FRP for other uses. In addition, the FRP for the printed circuit board is required to have a high quality specification, such as absence of a void and a narrow acceptable range of variance in its thickness after FRP molding.

Accordingly, many FRPs for the printed circuit board are produced by the Hand Lay-up (HLU) method. The Hand Lay-up method is the production method wherein a varnish having a resin dissolved therein is applied to an aggregate by using a coating machine, which is then followed by drying it so as to remove a solvent and cure it by heating (PTL 1). In the Hand Lay-up method, if a thermosetting resin is applied to the aggregate in advance, the workability in the process can be improved and the load to a surrounding environment can be lowered.

However, when an aggregate such as an aramid unwoven cloth without a calendar treatment, a thin glass paper, and a thin woven clothe is used, they are low in the strength as the aggregate; and thus, upon applying the varnish followed by solvent removal, drying, and thermal curing, the weight thereof outweighs the allowable load of the aggregate, resulting in a poor workability such as a cut of the aggregate and a breakage of the aggregate upon narrowing a gap of the coater so as to control the amount of the resin to be applied.

In addition, the FRP for a printed circuit board needs to satisfy both a high accuracy of the thickness after lamination and a filling property (moldability) of the resin into an inner layer circuit pattern. Therefore, it is necessary to produce the FRP precursors having different amounts of the resin attached to the aggregate with the difference of several percentages by mass, or the FRP precursors having different curing times of the thermosetting resin, or the FRP precursors obtained from combination of them, or the like, so that plural FRP precursors need to be produced from one aggregate; and thus, the process thereof is cumbersome. Moreover, because each of these FRP precursors is produced by different coating condition, loss of the material used in the production thereof is significant.

Accordingly, there is a method for producing the FRP precursor wherein the thermosetting resin is not applied directly to the aggregate, but the thermosetting resin is previously made to a resin film in a form of a film and then the said resin film and the aggregate are heated and pressed so as to be adhered (PTL 2).

In this method, however, because the resin is filled into a bulk gap of the aggregate, when the adhesion is conducted under vacuum, response to a trouble and efficiency in workability and the like are not so good. On the other hand, when the adhesion is conducted in an atmosphere, filling of the resin into the aggregate is poor, which can cause a void therein. In order to enhance the filling property, if the resin's viscosity is lowered by raising a lamination temperature, or if a pressure to be applied is increased so as to enhance the filling property into the aggregate, the resin spouts out from an edge portion thereof or the thickness of the resin varies in the plane thereof, so that it is difficult to obtain a good product.

Accordingly, a method is proposed wherein heating and pressing are conducted from the central portion so as to pushing out an air successively (PTL 3). In this method, however, the heating condition is different between the central portion and the edge portion, so that the curing degree of the thermosetting resin becomes different in the plane. In addition, because the roll-lamination treatment is carried out more than once, the production equipment needs to be provided with many heating and pressing rolls.

Moreover, in the above-mentioned production method, the resin's viscosity is lowered by heating. In this method, however, a heat source is a heating and pressing roll so that the surface of the resin to be impregnated into the aggregate is the farthest from the heat source. In addition, when the heating and pressing roll is contacted with the aggregate, a heat of the heating and pressing roll is taken away by the aggregate thereby causing lowering of the resin temperature and thus leading to an increase in the viscosity thereof; as a result, it can cause significant deterioration of the resin's fluidity (impregnability).

Also, in the above-mentioned production method, impregnation of the thermosetting resin into the aggregate is made by heating the thermosetting resin so as to decrease the viscosity thereof; however, if the thermosetting resin is overheated, the thermosetting resin starts to cure, which can cause an increase in the viscosity of the thermosetting resin. Accordingly, in the method wherein the thermosetting resin is heated so as to decrease the viscosity thereof, there is an upper limit in the heating. Moreover, if it is aimed to decrease the thermal expansion coefficient and raise the glass transition temperature by using a filler and a polymer component, it is difficult to achieve this aim and the decrease in the viscosity of the thermosetting resin at the same time.

### CITATION LIST

### Patent Literature

PTL 1: Japanese Patent Laid-Open Publication No. H01-272416
PTL 2: Japanese Patent Laid-Open Publication No. 2011-132535
PTL 3: Japanese Patent Laid-Open Publication No. H11-114953

### SUMMARY OF INVENTION

### Technical Problem

The problem of the present invention is to provide a method for producing an FRP precursor and a device for producing an FRP precursor wherein the said FRP precursor is excellent in impregnability of a thermosetting resin as well as in heat resistance of the FRP precursor to be obtained.

### Solution to Problem

Inventors of the present invention carried out an extensive investigation, and as a result, they found that the problem mentioned above can be solved by the method for producing the FRP precursor and the device for producing the FRP precursor that will be described below.

Namely, the present invention is as follows.
[1] A method for producing an FRP precursor, wherein the method is to produce the FRP precursor by adhering a thermosetting resin film to one surface of an aggregate that is in a form of sheet, the method comprising:

an attaching process to attach an organic solvent to the one aggregate's surface, and

a film press-adhering process to obtain the FRP precursor wherein under a normal pressure, of both surfaces of the film, an aggregate-side film surface, which is a surface in an aggregate side thereof, is press-adhered to the one aggregate's surface which is attached with the organic solvent.
[2] The method for producing the FRP precursor according to [1], wherein the method further comprises a heating process to heat from an opposite-to-aggregate-side film surface of the both surfaces of the film, the opposite-to-aggregate-side film surface being a film surface which is in an opposite side to the aggregate-side film surface.
[3] A method for producing an FRP precursor, wherein the method is to produce the FRP precursor by adhering each of a pair of thermosetting resin films to each of both surfaces of an aggregate that is in a form of a sheet, the method comprising:

an attaching process to attach an organic solvent to both aggregate's surfaces, which are both surfaces of the aggregate, and

a film press-adhering process to obtain the FRP precursor wherein under a normal pressure, of both surfaces of one film of the pair of the films, one aggregate-side film surface, which is a surface in an aggregate side thereof, is press-adhered to one surface of the both aggregate's surfaces which are attached with the organic solvent, and of both surfaces of another film of the pair of the films, an another aggregate-side film surface, which is a surface in an aggregate side thereof, is press-adhered to another surface of the both aggregate's surfaces which are attached with the organic solvent.
[4] The method for producing the FRP precursor according to [3], wherein the method further comprises a heating process to heat from each of opposite-to-aggregate-side film surfaces of the both surfaces of the pair of the films, the opposite-to-aggregate-side film surface being a film surface which is in an opposite side to the aggregate-side film surface.
[5] The method for producing the FRP precursor according to any one of [1] to [4], wherein the method comprises an attached amount adjusting process to adjust an amount of the organic solvent attached to the aggregate.
[6] The method for producing the FRP precursor according to any one of [1] to [5], wherein the attaching process comprises a process to soak the aggregate into the organic solvent.
[7] The method for producing the FRP precursor according to any one of [1] to [6], wherein a volume and a weight of the organic solvent attached to the aggregate satisfy Formula (1) and Formula (2):

Attached Organic Solvent Volume=(Aggregate's Bulk Volume−Aggregate's True Volume)×α, (1)
however, coefficient α is in a range of 0.1 to 0.8;

(Aggregate's Bulk Volume−Aggregate's True Volume)×Specific Gravity of Thermosetting Resin Film=Attached Organic Solvent Weight×β. (2)
however, coefficient β is less than 0.4.
[8] A device for producing an FRP precursor, wherein the device is used in the method for producing the FRP precursor according to [1] or [2], the device comprising:

an attaching means to attach an organic solvent to one aggregate's surface, and

a film press-adhering process to obtain the FRP precursor wherein under a normal pressure, of both surfaces of the film, an aggregate-side film surface, which is a surface in an aggregate side thereof, is press-adhered to the one aggregate's surface which is attached with the organic solvent.
[9] A device for producing an FRP precursor, wherein the device is used in the method for producing the FRP precursor according to [3] or [4], the device comprising:

an attaching means to attach an organic solvent to both aggregate's surfaces, which are both surfaces of the aggregate, and

a film press-adhering means to obtain the FRP precursor wherein under a normal pressure, of both surfaces of one film of the pair of the films, one aggregate-side film surface, which is a surface in an aggregate side thereof, is press-adhered to one surface of the both aggregate's surfaces which are attached with the organic solvent, and of both surfaces of another film of the pair of the films, an another aggregate-side film surface, which is a surface in an aggregate side thereof, is press-adhered to another surface of the both aggregate's surfaces which are attached with the organic solvent.

### Advantageous Effects of Invention

According to the present invention, the method for producing the FRP precursor and the device for producing the FRP precursor, wherein the said FRP precursor is excellent in impregnability of a thermosetting resin as well as in heat resistance of the FRP precursor to be obtained, can be provided.

### BRIEF DESCRIPTION OF DRAWINGS

FIG. 1 is a conceptual diagram of the method for producing the FRP precursor and the device for producing the FRP precursor according to the present invention.

### DESCRIPTION OF EMBODIMENTS

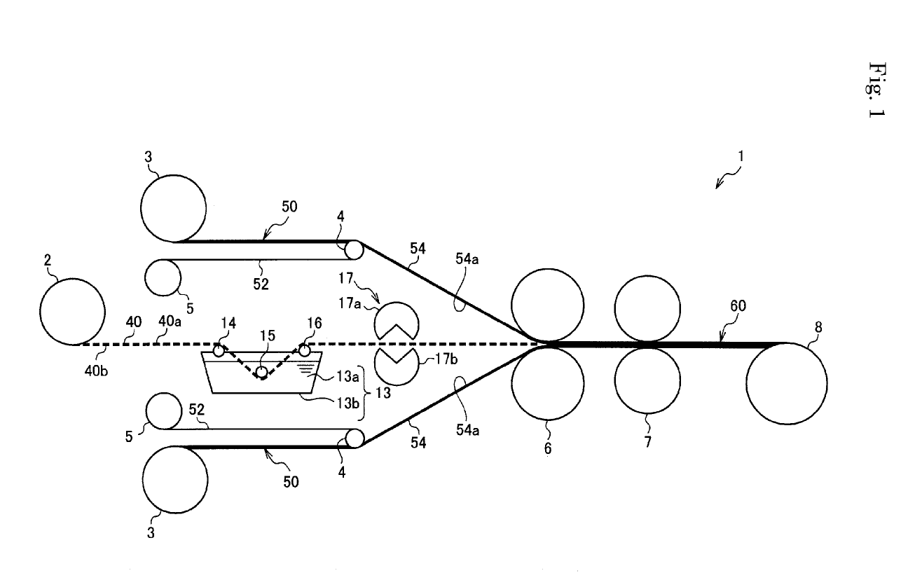

With referring to FIG. 1, explanation will be made with regard to embodiments of the FRP precursor production method and the FRP precursor production device 1 according to the present invention. Meanwhile, the FRP precursor production device 1 will be explained as the device to adhere each of a pair of resin films (thermosetting resin films) 54 to both surfaces of an aggregate 40 in a form of a sheet; however, the device may also be the one in which one resin film 54 is adhered to only one surface of the aggregate 40 in a form of a sheet. In this case, one resin film send-out device 3, one protection film peel-off mechanism 4, and one protection film roll-up device 5, all of which are disposed in a lower side (or in a upper side) of the aggregate 40 in FIG. 1, are not necessary.

The FRP precursor production device 1 is placed under a normal pressure. The FRP precursor production method according to the present invention can be conducted by the FRP precursor production device 1.

The FRP precursor production device 1 is provided with an aggregate send-out device 2, a pair of the resin film send-out devices 3 and 3, an organic solvent attaching mechanism 13, a sheet heating-and-pressing device 6, and an FRP precursor roll-up device 8. Preferably, the FRP precursor production device 1 is further provided with a sheet pressing-and-cooling device 7, an attached amount adjusting device 17, a pair of the protection film peel-off mechanisms 4 and 4, and a pair of the protection film roll-up devices 5 and 5.

The aggregate send-out device 2 is the device wherein a roll to which the aggregate 40 in a form of a sheet is rolled up is rotated to a direction opposite to a roll-up direction thereby sending out the aggregate 40 that is rolled up in a roll. In FIG. 1, the aggregate send-out device 2 sends out the aggregate 40 from a lower side of the roller toward the organic solvent attaching mechanism 13.

The organic solvent attaching mechanism 13 is provided with an organic solvent 13a, a vessel 13b, and conversion rollers 14, 15, and 16. In the organic solvent attaching mechanism 13, the aggregate 40 which is sent out from the aggregate send-out device 2 is sunk into the organic solvent 13a so as to attach the organic solvent 13a to a front surface 40a and a back surface 40b of the aggregate 40. The organic solvent attaching mechanism 13 sends out the aggregate 40 which is attached with the organic solvent 13a toward the attached amount adjusting device 17.

With regard to the organic solvent 13a, organic solvents that can be used to prepare a varnish of a thermosetting resin composition to be described later may be exemplified.

The vessel 13b is not particularly restricted provided that it can store the organic solvent 13a and that the width thereof is wider than the width of the aggregate 40. Predetermined amount of the organic solvent 13a is stored in the vessel 13b.

All of the conversion rollers 14, 15, and 16 are the rollers which convert the moving direction of the aggregate 40. The conversion rollers 14 and 16 are located above the vessel 13b and in the front side and the far side with respect to the sending direction of the aggregate 40 whereby the aggregate 40 converts its direction in the upper side thereof. The conversion roller 15 is arranged such that the aggregate 40 may convert its direction in the lower side thereof and that the lower side of the conversion roller 15 may be located below a surface of the organic solvent 13a in the vessel 13b. In FIG. 1, the conversion roller 15 is sunk in the organic solvent 13a.

In the method for producing the FRP precursor of the present embodiment, by attaching the organic solvent 13a to the front surface 40a and the back surface 40b of the aggregate 40 in advance, in the subsequent film pressing-and-adhering process, the aggregate-side film surface 54a can be locally dissolved so as to make it in a state of a paste. By so doing, viscosity of the thermosetting resin decreases thereby facilitating impregnation thereof to the aggregate 40; and as a result, the FRP precursor having a good impregnability into the aggregate 40 can be produced.

The attached amount adjusting device 17 has attached amount adjusting nozzles 17a and 17b which are located in the side of the front surface 40a and in the side of the back surface 40b of the aggregate 40, respectively, this aggregate being sent out from the organic solvent attaching mechanism 13 wherein the organic solvent 13a is attached thereto. The attached amount adjusting nozzle 17a is a nozzle to suck the organic solvent 13a excessively attached to the front surface 40a of the aggregate 40 in order to adjust the amount of the organic solvent 13a attached to the front surface 40a. The attached amount adjusting nozzle 17b is a nozzle to suck the organic solvent 13a excessively attached to the back surface 40b of the aggregate 40 in order to adjust the amount of the organic solvent 13a attached to the back surface 40b. The aggregate 40 whose excess amount of the organic solvent 13a is removed by the attached amount adjusting device 17 progresses toward the sheet heating-and-pressing device 6.

Each of the resin film send-out devices 3 has a roll to which a protection-film-attached resin film 50 is rolled up and a supporting mechanism to rotatably support the roll with imparting a prescribed tension to the protection-film-attached resin film 50 that is sent out.

Each of the resin send-out devices 3 rotates the roll to which the protection-film-attached resin film 50 is rolled up to a direction opposite to a roll-up direction thereof so as to send out the protection-film-attached resin film 50 that is rolled up to the roll. As described later, the protection-film-attached resin film 50 is a film in a form of a sheet including a resin film 54, and a protection film 52 that is laminated to an aggregate-side film surface (of both surfaces of the resin film 54, the surface in the side of the aggregate 40) 54a, which is one surface of the resin film 54, and a carrier film (not shown in the drawing) which is laminated to the opposite side of the protection film 52 of the resin film 54.

Each of the pair of the resin film send-out devices 3 and 3 each is located in a side of a front surface 40a and a side of a back surface 40b of the sent-out aggregate 40, respectively.

The one resin film send-out device 3 is located in the side of the front surface 40a of the sent-out aggregate 40, wherein the one protection-film-attached resin film 50 is sent out from the lower side of the roller to the one protection film peel-off mechanism 4 in such a way that the protection film 52 may be in the side of the sent-out aggregate 40.

In the same way, the other resin film send-out device 3 is located in the side of the back surface 40b of the sent-out aggregate 40, wherein the other protection-film-attached resin film 50 is sent out from the upper side of the roller to the other protection film peel-off mechanism 4 in such a way that the protection film 52 may be in the side of the sent-out aggregate 40.

The pair of the protection film peel-off mechanisms 4 and 4 are conversion rollers, each of which is located in the side of the front surface 40a and the side of the back surface 40b of the sent-out aggregate 40, respectively.

The one protection film peel-off mechanism 4 receives, onto the surface of the rotating conversion roller, the protection-film-attached resin film 50 which is sent out from the one resin film send-out device 3 toward the one protection film peel-off mechanism 4, wherein the one resin film 54 of the one protection-film-attached resin film 50 is made to progress toward the sheet heating-and-pressing device 6, while the one protection film 52 is made to progress toward the one protection film roll-up device 5, so that the one protection film 52 is peeled off from the one protection-film-attached resin film 50. In this way, the aggregate-side film surface 54a of the one resin film 54 is exposed.

In the same way, the other protection film peel-off mechanism 4 receives, onto the surface of the rotating conversion roller, the protection-film-attached resin film 50 which is sent out from the other resin film send-out device 3 toward the other protection film peel-off mechanism 4, wherein the other resin film 54 of the other protection-film-attached resin film 50 is made to progress toward the sheet heating-and-pressing device 6, while the other protection film 52 is made to progress toward the other protection film roll-up device 5, so that the other protection film 52 is peeled off from the other protection-film-attached resin film 50. In this way, the aggregate-side film surface 54a of the other resin film 54 is exposed.

Each of the pair of the protection film roll-up devices 5 and 5 is located in the side of the front surface 40a and the side of the back surface 40b of the sent-out aggregate 40, respectively, and rolls up the protection films 52 and 52 that are peeled off by the pair of the protection film peel-off mechanisms 4 and 4.

The sheet heating-and-pressing device 6 has a pair of heating and compression rollers and a compression-force-imparting mechanism (not shown in the drawing) to impart a compression force to the pair of the heating and compression rollers. The pair of the heating and compression rollers have heating bodies inside thereof so as to heat with a prescribed set temperature.

The sheet heating-and-pressing device 6 forms the FRP precursor 60 in a form of a sheet by press-adhering the resin films 54 and 54 to the aggregate 40 that is entered thereto by means of the pair of the rotating heating and compression rollers while sending-out the FRP precursor 60 toward the sheet pressing-and-cooling device 7. Specifically, the aggregate 40 which is sent out from the attached amount adjusting device 17 and the resin films 54 and 54 which are sent out from the pair of the protection film peel-off mechanisms 4 and 4, respectively, enter into between the pair of the heating and compression rollers in such a way that the front surface 40a and the back surface 40b of the aggregate 40 which is sent out from the aggregate send-out device 2 may be laminated to each of the resin films 54 and 54 which is sent out from the pair of the protection film peel-off mechanisms 4 and 4, respectively.

At this time, the one resin film 54 is laminated to the aggregate 40 in such a way that the side of the aggregate-side film surface 54a of the one resin film 54 may be adhered to the side of the front surface 40a of the aggregate 40, and the other resin film 54 is laminated to the aggregate 40 in such a way that the side of the aggregate-side film surface 54a of the other resin film 54 may be adhered to the side of the back surface 40b of the aggregate 40; in this way, the FRP precursor 60 is formed. The FRP precursor 60 that is sent out from the sheet heating-and-pressing device 6 is in a high temperature state.

The sheet pressing-and-cooling device 7 has a pair of the cooling and compression rollers and a compression-force-imparting mechanism (not shown in the drawing) to impart a compression force to the pair of the cooling and compression rollers. The pair of the cooling and compression rollers compress and cool the FRP precursor 60 in the high temperature state, which is sent out from the sheet heating-and-pressing device 6, by the pair of the rotating, cooling and compression rollers, and then send out this FRP precursor to the FRP precursor roll-up device 8.

The FRP precursor roll-up device 8 has a roll to roll up the FRP precursor 60 in a form of a sheet which is sent out from the sheet pressing-and-cooling device 7, as well as a driving mechanism to rotate the roll (not shown in the drawing).

The FRP precursor production device 1 described above is operated in the way as described below.

Firstly, the aggregate 40 in a form of a sheet is sent out from the aggregate send-out device 2 toward the organic solvent attaching mechanism 13. At this time, both the front surface 40a and the back surface 40b of the aggregate 40 are exposed.

Next, the aggregate 40 is soaked into the organic solvent 13a in the vessel 13b by means of the organic solvent attaching mechanism 13 so as to attach the organic solvent 13a to the front surface 40a and the back surface 40b of the aggregate 40, the both surfaces having been exposed. By so doing, the organic solvent is attached to the front surface 40a and the back surface 40b of the aggregate 40 (attaching process).

Next, of the organic solvent 13a that is attached to the front surface 40a and the back surface 40b of the aggregate 40, an excess amount of the organic solvent 13a is sucked by the attached amount adjusting nozzle 17a and the attached amount adjusting nozzle 17b, respectively. By so doing, the amount of the organic solvent attached to the soaked aggregate 40 is adjusted (attached amount adjusting process). In this way, the front surface 40a and the back surface 40b of the aggregate 40 becomes a state that an appropriate amount of the organic solvent 13a is attached thereto.

On the other hand, the one protection-film-attached resin film 50 is sent out from the lower side of the roller of the one resin film send-out device 3 toward the one protection film peel-off mechanism 4 in such a way that the protection film 52 may be in the side of the sent-out aggregate 40. The other protection-film-attached resin film 50 is sent out from the upper side of the roller of the other resin film send-out device 3 toward the other protection film peel-off mechanism 4 in such a way that the protection film 52 may be in the side of the sent-out aggregate 40.

Next, when the one protection-film-attached resin film 50 that is sent out changes the direction thereof upon reaching the conversion roller, i.e., the one protection film peel-off mechanism 4, the one protection film 52 is peeled off from the one protection-film-attached resin film 50 in such a way that the aggregate-side film surface 54a may be exposed, whereby the one resin film 54 is progressed toward the sheet heating-and-pressing device 6. In this way, the aggregate-side film surface 54a of the one resin film 54 is exposed.

In the same way, when the other protection-film-attached resin film 50 that is sent out changes the direction thereof upon reaching the conversion roller, i.e., the other protection film peel-off mechanism 4, the other protection film 52 is peeled off from the other protection-film-attached resin film 50 in such a way that the aggregate-side film surface 54a may be exposed, whereby the other resin film 54 is progressed toward the sheet heating-and-pressing device 6. In this way, the aggregate-side film surface 54a of the other resin film 54 is exposed.

Each of the pair of the protection films 52 and 52 that are peeled off is rolled up by the pair of the protection film roll-up devices 5 and 5, respectively.

The aggregate 40 that is sent out from the organic solvent attaching mechanism 13 and the resin films 54 and 54 each of which is sent out from the pair of the protection film peel-off mechanisms 4 and 4, respectively, enter into the pair of the heating and compression rollers in such a way that each of one and another resin films 54 and 54 may be laminated to the aggregate 40 that is sent out from the organic solvent attaching mechanism 13.

At this time, the resin film 54 is in the state of being mounted on the aggregate 40; and thus, the organic solvent 13a is in the state of being disposed between the resin film 54 and the aggregate 40, whereby causing the organic solvent 13a to contact with the aggregate-side film surface 54a of the resin film 54.

When the organic solvent 13a contacts with the aggregate-side film surface 54a, the organic solvent 13a causes to locally melt the aggregate-side film surface 54a of the resin film 54 thereby leading it to a state of a paste, so that the viscosity of the thermosetting resin around the aggregate-side film surface 54a of the resin film 54 can be lowered. Then, because the resin film 54 and the aggregate 40 are press-adhered by means of the pair of the heating and compression rollers, the thermosetting resin whose viscosity is lowered is impregnated into the aggregate 40. In this way, the pair of the resin films 54 and 54 are press-adhered to the aggregate 40 by means of the sheet heating-and-pressing device 6 to obtain the FRP precursor 60 (film press-adhering process).

That is to say, in the film press-adhering process, at the time when the resin film 54 is adhered to the aggregate 40 under an atmosphere, where a good workability is prevailing, the resin film 54 is not directly melted and flowed by heating the aggregate-side film surface 54a over a carrier film by means of the heating and compression roller of the sheet heating-and-pressing device 6, but the resin film 54 is melted by the organic solvent 13a; and thus, not only it is difficult to cause uneven melting but also the portion not impregnated to the aggregate 40 can be reduced, so that the FRP precursor 60 can be produced efficiently.

The pair of the heating and compression rollers heat each of the films 54 from the surface thereof in an opposite side to the aggregate 40 (opposite-to-aggregate-side film surface) in such a way that the aggregate-side film surface 54a which is in the side of the aggregate 40 of each resin films 54 may be melted by the heated organic solvent 13a (heating process). Because the resin film 54 is heated by the heat from the pair of the heating and compression rollers, melting of the thermosetting resin of the resin film 54 is facilitated.

The FRP precursor 60 which is sent out from the sheet heating-and-pressing device 6 is pressed further and cooled by the sheet pressing-and-cooling device 7.

The FRP precursor 60 which is sent out from the sheet pressing-and-cooling device 7 is rolled up by the FRP precursor roll-up device 8.

Meanwhile, so far the explanation has been made with regard to the organic solvent attaching mechanism 13 that is provided with the organic solvent 13a, the vessel 13b, and the conversion rollers 14, 15, and 16; however, the organic solvent attaching mechanism 13 is not particularly restricted to the above so far as the organic solvent 13a can be attached to both surfaces of the aggregate 40; and thus, coating of the organic solvent may be conducted, for example, by application, printing, brushing, or the like.

The FRP precursor produced by the FRP precursor production device 1 will be explained.

Illustrative example of the aggregate of the FRP precursor to be produced includes a woven cloth and a unwoven cloth that are obtained by using single body of or a mixture of inorganic fiber substrates such as glass and carbon, organic fiber substrates such as aramid and cellulose, and metal fiber substrates such as iron, copper, aluminum, and alloys of these metals.

The thermosetting resin film to be used in the production method of the present invention is a film which includes a thermosetting resin and is in a form of a film made of a composition including a thermosetting resin (hereinafter, this is also referred to as “thermosetting resin composition”).

Illustrative example of the thermosetting resin includes a phenol resin, a urea resin, a furan resin, and an epoxy resin. Especially, in the items of workability, handling properties, and price, an epoxy resin is favorable.

As to the epoxy resin, epoxy resins having two or more functionalities are preferable. Illustrative example of the epoxy resin having two or more functionalities includes bisphenol-based epoxy resins such as a bisphenol-A-based epoxy resin, a bisphenol-F-based epoxy resin, and a bisphenol-AD-based epoxy resin; alicyclic epoxy resins; novolak-based epoxy resins such as a phenol novolak-based epoxy resin, a cresol novolak-based epoxy resin, a bisphenol-A novolak-based epoxy resin, and an aralkyl novolak-based epoxy resin; diglycidyl ether compounds of polyfunctional phenols; and hydrogenated products of these compounds. These epoxy resins may be used singly, or two or more of them may be used concurrently.

If flame retardance is required, a halogenated epoxy resin may be blended thereto. In addition, in order to satisfy the flame retardance without addition of the halogenated epoxy resin, compounds generally called as a flame retardant or a flame retardant auxiliary, such as tetrabromobisphenol-A, decabromodiphenyl ether, antimony oxide, tetraphenyl phosphine, organic phosphorous compounds, and zinc oxide, may be added thereto.

When the epoxy resin is used as the thermosetting resin, an epoxy resin curing agent may be used.

Illustrative example of the epoxy resin curing agent includes a phenol resin, an amine compound, an acid anhydride, a boron trifluoride monoethylamine, an isocyanate, a dicyan diamide, and a urea resin.

Illustrative example of the phenol resin includes novolak-based phenol resins such as a phenol novolak resin and a cresol novolak resin; a naphthalene-based phenol resin, a high-ortho-based novolak phenol resin, a terpene-modified phenol resin, a terpene phenol-modified phenol resin, an aralkyl-based phenol resin, a dicyclopentadiene-based phenol resin, a salicylaldehyde-based phenol resin, and a benzaldehyde-based phenol resin. Among them, a phenol novolak resin, a cresol novolak resin, and a partially modified aminotriazine novolak resin are preferable.

Illustrative example of the amine compound includes aliphatic amines such as triethylene tetramine, tetraethylene pentamine, and diethylamino propylamine; and aromatic amines such as m-phenylene diamine and 4,4′-diamino diphenyl methane.

Illustrative example of the acid anhydride includes phthalic anhydride, methyltetrahydrophthalic anhydride, tetrahydrophthalic anhydride, and hexahydrophthalic anhydride. These epoxy resin curing agents may be used singly, or two or more of them may be used concurrently.

Amount of the epoxy resin curing agent to be blended is preferably in the range of 0.3 to 1.5 equivalents as the equivalent ratio of the curing agent's reactive group relative to 1 epoxy equivalent of the epoxy resin. When the blended amount of the epoxy resin curing agent is within the above-mentioned range, the cure degree can be readily controlled, so that the productivity can be enhanced.

The thermosetting resin composition may further contain a curing accelerator.

Illustrative example of the curing accelerator includes an imidazole compound, an organic phosphorous compound, a tertiary amine, and a quaternary amine salt. The imidazole compound may be an imidazole compound having latency by masking an imidazole's secondary amino group with acrylonitrile, isocyanate, melamine, acrylate, or the like. Illustrative example of the imidazole compound to be used here includes imidazole, 2-methyl imidazole, 4-ethyl-2-methyl imidazole, 2-phenyl imidazole, 2-undecyl imidazole, 1-benzyl-2-methyl imidazole, 2-heptadecyl imidazole, 4,5-diphenyl imidazole, 2-methyl imidazoline, 2-ethyl-4-methyl imidazoline, 2-undecyl imidazoline, and 2-phenyl-4-methyl imidazoline.

In addition, a photoinitiator which initiates curing by generating a radical, an anion, or a cation by photodegradation may be used as well.

These curing accelerators may be used singly, or two or more of them may be used concurrently.

Amount of the curing accelerator to be blended is preferably in the range of 0.01 to 20 parts by mass relative to 100 parts by mass of the epoxy resin. When the amount thereof is 0.01 or more parts by mass, a sufficient curing acceleration effect can be obtained, and when the amount thereof is 20 or less parts by mass, the thermosetting resin composition is excellent not only in storage stability and physical properties of the cured product but also in economy.

The thermosetting resin composition may further contain a filler in order to improve non-transmitting property and abrasion resistance as well as to increase the amount thereof.

Illustrative example of the filler includes oxides such as silica, aluminum oxide, zirconia, mullite, and magnesia; hydroxides such as aluminum hydroxide, magnesium hydroxide, and hydrotalcite; nitride ceramics such as aluminum nitride, silicon nitride, and boron nitride; natural minerals such as talc, montmorillonite, and saponite; and metal particles and carbon particles.

As compared with the resin, these fillers have wider specific gravities from low to high; thus, the amount of the filler is preferably counted not with parts by mass but with a volume rate.

Amount of the filler to be added is significantly different in accordance with the purpose of the addition thereof; however, the amount thereof is preferably in the range of 0.1 to 65% by volume in the volume of the solid portion of the thermosetting resin composition. When the amount thereof is 0.1% or more by volume, if the addition thereof is made with the purposes for coloring and obtaining a non-transmitting property, sufficient effects can be expressed. When the amount thereof is 65% or less by volume, not only a viscosity of the composition can be suppressed but also the amount thereof can be increased without deteriorating workability and adhesion property.

It must be noted here that the solid portion in this specification means the components other than volatile substances such as water and an organic solvent to be mentioned later in the composition. Namely, the solid portion includes those that are, at room temperature around 25° C., in a liquid state, a syrup state, and a waxy state; and therefore, this does not necessarily mean it is in a solid state.

As necessary, even compounds other than the above-mentioned compounds may be mixed so far as the effects of the present invention are not damaged. For example, in order to impart the cured resin with a resin tackiness and to enhance the adhesiveness upon adhesion, a flexible material may be added thereto.

Illustrative example of the flexible material includes polystyrene, polyolefin, polyurethane, acryl resin, acrylonitrile rubber, polyvinyl alcohol, substances modified with an epoxy group or a carboxy group so as to incorporate these compounds into a curing system, and a phenoxy that is previously made to a macromolecule by reacting with an epoxy resin. These flexible materials may be used singly, or two or more of them may be used concurrently.

Amount of the flexible material to be blended is preferably in the range of 3 to 200 parts by mass relative to the solid portion of the thermosetting resin composition. When the amount thereof is 3 or more parts by mass, the flexibility can be imparted sufficiently well; when the amount thereof is 200 or less parts by mass, the modulus of the cured product can be kept well. However, if a decrease of the modulus does not give an impact to an intended specification, the upper limit value thereof may be arbitrarily determined in accordance with the purpose without being bound by the above-mentioned range.

In order to make the thermosetting resin composition uniform, it is preferable to make the thermosetting resin composition a varnish state by dissolving and/or dispersing it in an organic solvent.

Illustrative example of the organic solvent includes acetone, methyl ethyl ketone, toluene, xylene, cyclohexanone, 4-methyl-2-pentanone, ethyl acetate, ethylene glycol monoethyl ether, dipropylene glycol monomethyl ether, dipropylene glycol monoethyl ether, tripropylene glycol monomethyl ether, N,N-dimethyl formamide, and N,N-dimethyl acetamide. These organic solvents may be used singly, or two or more of them may be used concurrently. If there is no problem in the property thereof, powder mixing in which the afore-mentioned materials are mixed in a powder state may be conducted, or the composition may be made to an aqueous solution by suspending it. Further alternatively, homogenization of the thermosetting resin composition may be conducted by direct stirring of it at the temperature in which curing of the thermosetting resin composition does not take place eminently as well as under the temperature in which the thermosetting resin composition is in a liquid state.

In order to increase in dispersibility of the filler and in adhesiveness to the aggregate or to an objective substance, a coupling agent may be added thereto. Illustrative example of the coupling agent includes silane coupling agents containing a vinyl group, such as vinyl trichlorosilane and vinyl triethoxy silane; silane coupling agents containing an epoxy group, such as 3-glycidoxypropyl trimethoxy silane and 2-(3,4-epoxycyclohexypethyl trimethoxy silane; silane coupling agents containing an amino group, such as 3-aminopropyl trimethoxy silane and N-2-(aminoethyl)-3-aminopropyl triethoxy silane; and titanate-based coupling agents. These coupling agents may be used singly, or two or more of them may be used concurrently.

Amount of the coupling agent to be added is preferably in the range of 0.01 to 5 parts by mass relative to the solid portion of the thermosetting resin composition. When the amount thereof is 0.01 or more parts by mass, the surface of the aggregate as well as the surface of the filler can be satisfactorily covered; when the amount thereof is 5 or less parts by mass, the event of excessive coupling agent can be suppressed.

Next, the thermosetting resin composition obtained by the blending mentioned above is applied onto a carrier film; and after unnecessary organic solvent is removed, the thermosetting resin composition is thermally cured to obtain a film of the said resin composition. Meanwhile, the thermal cure at this time is conducted with a purpose to make the thermosetting resin composition a so-called semi-cured state (B stage), wherein it is preferable to make the thermosetting resin composition semi-cured so as to give the viscosity thereof suitable in lamination workability.

Illustrative example of the carrier film includes films of organic substances such as polyethylene terephthalate (PET), biaxially oriented polypropylene (OPP), polyethylene, polyvinyl fluorate, and polyimide; films of copper and aluminum, as well as alloy films of these metals; and these organic films or metal films whose surfaces are subjected to a release treatment by a release agent.

The workability is favorable if after the thermosetting resin composition is applied to the carrier film and then semi-cured, the carrier film is laminated to this surface so as to sandwich the thermosetting resin composition, and then this is rolled up.

Kind of the organic solvent to be used in order to facilitate impregnation of the thermosetting resin that constitutes the film into the aggregate by way of attaching thereof to the aggregate's surface may be arbitrarily determined in accordance with the kind or like of the thermosetting resin that constitutes the film; however, an organic solvent that can be used for preparation of the varnish of the thermosetting resin is preferable.

The attachment method is not particularly restricted; however, illustrative example of the preferable attachment method includes a method in which a prescribed amount of the organic solvent is applied by a gravure roll, and a method in which after the aggregate is soaked into the organic solvent so as to be impregnated therewith, unnecessary portion of the organic solvent is removed.

If the moving time after attachment by soaking till the heating and pressing roll is too long, the organic solvent evaporates; and thus, it is preferable to dispose the heating and pressing roll in a position within 10 seconds after soaking, while it is more preferable to dispose the roll in a position within 5 seconds after soaking.

With regard to the amount of the organic solvent to be attached by soaking, it is preferable to apply the organic solvent with the amount that is obtained by calculation with Formula (1) and Formula (2):

Attached Organic Solvent Volume=(Aggregate's Bulk Volume−Aggregate's True Volume)×α, (1)
however, coefficient α is in a range of 0.1 to 0.8;

(Aggregate's Bulk Volume−Aggregate's True Volume)×Specific Gravity of Thermosetting Resin Film=Attached Organic Solvent Weight×β. (2)
however, coefficient α is in a range of 0.1 to 0.8;

When the coefficient α of Formula (1) is 0.1 or more, the amount of the organic solvent is sufficient, so that the thermosetting resin can be impregnated well. When the coefficient β of Formula (2) is less than 0.4, not only the thermosetting resin can be impregnated well, but also such problems as foaming due to an excess amount of the organic solvent at the time of curing and deterioration in the heat resistance after curing can be suppressed. From the same viewpoints, the coefficient α of Formula (1) is preferably in the range of 0.2 to 0.75, while more preferably in the range of 0.3 to 0.7. The coefficient β of Formula (2) is preferably in the range of 0.1 to 0.36, while more preferably in the range of 0.2 to 0.33.

The thermosetting resin film is laminated to the aggregate by heating and pressing in the way as mentioned above to obtain the FRP precursor. The FRP precursor thus obtained is cut to an arbitrary size, and it is then adhered to an intended substance and cured thermally.

### EXAMPLES

Next, the present invention will be explained in more detail by Examples described below; however, these Examples do not limit the present invention.

### [Production of the FRP Precursor]

### Example 1

To 100 parts by mass of a phenol novolak-based epoxy resin (N-660, manufactured by DIC Corp.) and 60 parts by mass of a cresol novolak resin (KA-1165, manufactured by DIC Corp.) were added 15 parts by mass of cyclohexane and 130 parts by mass of methyl ethyl ketone, and the resulting mixture was stirred well for dissolution. To this were added 180 parts by mass of aluminum hydroxide (CL-303, manufactured by Sumitomo Chemical Co., Ltd.) as the filler, 1 part by mass of a coupling agent (A-187, manufactured by Momentive Performance Materials, Inc.), and 2.5 parts by mass of an isocyanate-masked imidazole (G8009L. manufactured by DKS Co., Ltd.); and the resulting mixture was stirred for dissolution and dispersion to obtain a thermosetting resin varnish A with the nonvolatile fraction of 70% by mass.

The thermosetting resin varnish A thus obtained was applied to a PET film (G-2, manufactured by Teijin DuPont Films Japan Ltd.) having the width of 580 mm so as to give the application width of 525 mm with the thickness after drying being 18 μm to prepare a thermosetting resin film A.

When a minimum melt viscosity temperature of the thermosetting resin film A thus prepared was measured by using a rheometer (AR-200ex with a jig of 20 mmφ, manufactured by TA Instruments Japan Inc.) with the temperature raising rate of 3° C./minute, the minimum melt viscosity temperature thereof was 128° C.

Next, a mixed solvent of cyclohexane and methyl ethyl ketone (cyclohexane:methyl ethyl ketone=1:4 (mass ratio)) was applied to a glass cloth (weight: 48 g/m², IPC #1080, substrate width: 530 mm, manufactured by Nitto Boseki Co., Ltd.) as the aggregate by a gravure roller with the coating amount of 14 g/cm² (attaching process). This was sandwiched by the thermosetting resin films A, and then, by using a pressing and heating roll with the roll temperature of 120° C., the linear pressure of 0.2 MPa, and the rate of 2.0 m/minute, the thermosetting resin film A was impregnated to the aggregate by pressing (film press-adhering process). Then, it was cooled by a cooling roll and then rolled up to prepare the FRP precursor A.

Aspects of the glass cloth used in Example 1, the coefficient α calculated from Formula (1), and the coefficient β calculated from Formula (2) are shown below.
Bulk thickness of the glass cloth: 0.055 mm
Bulk volume of the glass cloth: 55 cm³/m²
True volume of the glass cloth: 21.3 cm³/m² (specific gravity of the glass: 2.55)
Bulk volume of the glass cloth—True volume of the glass cloth: 33.7 cm³/m²
Solvent volume: 16.9 cm³ (specific gravity of the mixed solvent: 0.83)
Solvent weight: 14 g (specific gravity of the thermosetting resin film: 1.7)
Coefficient α: 0.5
Coefficient β: 0.24

### Example 2

The thermosetting resin varnish A of Example 1 was applied to a PET film having the width of 580 mm so as to give the application width of 525 mm with the thickness after drying being 60 μm to prepare a thermosetting resin film B. The minimum melt viscosity temperature of the thermosetting resin film B measured with the same condition as Example 1 was 120° C., and the evaporated portion at 180° C. for 1 hour was 0.9% by mass.

A glass cloth (weight: 210 g/m², IPC #7628, substrate width: 530 mm, manufactured by Nitto Boseki Co., Ltd.) as the aggregate was soaked in a methyl ethyl ketone bath (attaching process); and then, an unnecessary portion of the organic solvent was removed so as to apply 48 g/m² of the organic solvent to the glass cloth. This was sandwiched by the thermosetting resin films B, and then, by using a pressing and heating roll with the roll temperature of 120° C., the linear pressure of 0.2 MPa, and the rate of 2.0 m/minute, the thermosetting resin film B was impregnated to the aggregate by pressing (film press-adhering process). Then, it was cooled by a cooling roll and then rolled up to prepare the FRP precursor B.

Aspects of the glass cloth used in Example 2, the coefficient α calculated from Formula (1), and the coefficient β calculated from Formula (2) are shown below.
Bulk thickness of the glass cloth: 0.180 mm
Bulk volume of the glass cloth: 180 cm³/m²
True volume of the glass cloth: 86.7 cm³/m² (specific gravity of the glass: 2.55)
Bulk volume of the glass cloth—True volume of the glass cloth: 93.3 cm³/m²
Solvent volume: 60 cm³ (specific gravity of the solvent (methyl ethyl ketone: 0.8)
Solvent weight: 14 g (specific gravity of the thermosetting resin film: 1.7)
Coefficient α: 0.65
Coefficient β: 0.31

### Example 3

The FRP precursor C was obtained by following the same procedure as Example 2 except that the amount of the organic solvent applied to the aggregate was changed to 69 g/m².

Aspects of the glass cloth used in Example 3, the coefficient a calculated from Formula (1), and the coefficient β calculated from Formula (2) are shown below.
Bulk thickness of the glass cloth: 0.180 mm
Bulk volume of the glass cloth: 180 cm³/m²
True volume of the glass cloth: 86.7 cm³/m² (specific gravity of the glass: 2.55)
Bulk volume of the glass cloth—True volume of the glass cloth: 93.3 cm³/m²
Solvent volume: 86.3 cm³ (specific gravity of the solvent (methyl ethyl ketone: 0.8)
Solvent weight: 14 g (specific gravity of the thermosetting resin film: 1.7)
Coefficient α: 1.0
Coefficient β: 0.47

### Example 4

After the FRP precursor C was prepared in the same way as Example 3, the PET in the both surfaces were removed; and then, the drying treatment thereof was carried out in a hot air dryer at 140° C. for the period of 2 minutes to prepare the FRP precursor D.

### Comparative Example 1

The FRP precursor E was prepared by following the same procedure as Example 1 except that the organic solvent was not applied to the aggregate.

### [Evaluation Methods]

The FRP precursors obtained in Examples and Comparative Example were evaluated with regard to the following items. The results thereof are shown in Table 1.

### (1) Impregnability to the Aggregate

After the FRP precursor was cooled by a liquid nitrogen, it was cut. And after the temperature thereof was resumed to room temperature (25° C.), the cut surface thereof was observed with an optical microscope for evaluation thereof in accordance with the following standards.
A: Existence of the unfilled portion was not recognized.
B: Existence of the unfilled portion was recognized.

### (2) Heat Resistance

Four sheets of each of the FRP precursors were piled, and copper foils (GTS-18: electrolytic copper foil with thickness of 18 μm, manufactured by Furukawa Electric Co., Ltd.) were laminated to the upper and lower surfaces thereof. This was sandwiched between the SUS-made mirror plates and then heat-molded with the product pressure of 3.0 MPa and the product temperature of 180° C. or higher for the period of 90 minutes to prepare a copper clad laminate having the copper foils on the both surfaces thereof.

This was cut to the size of a 200 mm square and placed in a drying oven at 200° C.; and the appearance thereof was confirmed every one hour to evaluate whether or not swelling was observed. These results are summarized in Table 1.

TABLE 1

| | | | | | Compar- |
|---|---|---|---|---|---|
| | | | | | ative |
| | Exam- | Exam- | Exam- | Exam- | Exam- |
| Item | ple 1 | ple 2 | ple 3 | ple 4 | ple 1 |
| (1) Impregnability | A | A | A | A | B |
| to aggregate | | | | | |
| (2) Heat resistance | No | No | Swelling | No | Swelling |
| | swelling | swelling | observed | swelling | observed |
| | in 5 | in 5 | in 2 | in 5 | in 3 |
| | hours | hours | hours | hours | hours |

From Table 1, it can be clearly seen that the FRP precursors obtained in Examples 1 to 4 are better in impregnability to the aggregate as compared with Comparative Example 1. Especially, the FRP precursors in Examples 1, 2, and 4 are highly compatible in both the impregnability to the aggregate and the heat resistance.

### REFERENCE SIGNS LIST

1 FRP precursor production device
2 Aggregate send-out device
3 Resin film send-out device
4 Protection film peel-off mechanism
5 Protection film roll-up device
6 Sheet heating-and-pressing device (film press adhering means)
7 Sheet pressing-and-cooling device
8 FRP precursor roll-up device
13 Organic solvent attaching mechanism (organic solvent attaching means)
17 Attached amount adjusting device
40 Aggregate
40a One aggregate's surface (one surface of both aggregate's surfaces)
40b Another aggregate's surface (another surface of both aggregate's surfaces)
50 Protection-film-attached resin film
52 Protection film
54 Resin film (film)
54a Aggregate-side film surface
60 FRP precursor

1. A method for producing an FRP precursor, wherein the method is to produce the FRP precursor by adhering a thermosetting resin film to one surface of an aggregate that is in a form of sheet, the method comprising:
an attaching process to attach an organic solvent to the one aggregate's surface, and
a film press-adhering process to obtain the FRP precursor wherein under a normal pressure, of both surfaces of the film, an aggregate-side film surface, which is a surface in an aggregate side thereof, is press-adhered to the one aggregate's surface which is attached with the organic solvent.

2. The method for producing the FRP precursor according to claim 1, wherein the method further comprises a heating process to heat from an opposite-to-aggregate-side film surface of the both surfaces of the film, the opposite-to-aggregate-side film surface being a film surface which is in an opposite side to the aggregate-side film surface.

3. A method for producing an FRP precursor, wherein the method is to produce the FRP precursor by adhering each of a pair of thermosetting resin films to each of both surfaces of an aggregate that is in a form of a sheet, the method comprising:
an attaching process to attach an organic solvent to both aggregate's surfaces, which are both surfaces of the aggregate, and
a film press-adhering process to obtain the FRP precursor wherein under a normal pressure, of both surfaces of one film of the pair of the films, one aggregate-side film surface, which is a surface in an aggregate side thereof, is press-adhered to one surface of the both aggregate's surfaces which are attached with the organic solvent, and of both surfaces of another film of the pair of the films, an another aggregate-side film surface, which is a surface in an aggregate side thereof, is press-adhered to another surface of the both aggregate's surfaces which are attached with the organic solvent.

4. The method for producing the FRP precursor according to claim 3, wherein the method further comprises a heating process to heat from each of opposite-to-aggregate-side film surfaces of the both surfaces of the pair of the films, the opposite-to-aggregate-side film surface being a film surface which is in an opposite side to the aggregate-side film surface.

5. The method for producing the FRP precursor according to claim 1, wherein the method comprises an attached amount adjusting process to adjust an amount of the organic solvent attached to the aggregate.

6. The method for producing the FRP precursor according to claim 1, wherein the attaching process comprises a process to soak the aggregate into the organic solvent.

7. The method for producing the FRP precursor according to claim 1, wherein a volume and a weight of the organic solvent attached to the aggregate satisfy Formula (1) and Formula (2):
Attached Organic Solvent Volume=(Aggregate's Bulk Volume−Aggregate's True Volume)×α, (1)
however, coefficient α is in a range of 0.1 to 0.8;
(Aggregate's Bulk Volume−Aggregate's True Volume)×Specific Gravity of Thermosetting Resin Film=Attached Organic Solvent Weight×β, (2)
however, coefficient β is less than 0.4.

8. A device for producing an FRP precursor, wherein the device is used in the method for producing the FRP precursor according to claim 1, the device comprising:
an attaching means to attach an organic solvent to one aggregate's surface, and
a film press-adhering process to obtain the FRP precursor wherein under a normal pressure, of both surfaces of the film, an aggregate-side film surface, which is a surface in an aggregate side thereof, is press-adhered to the one aggregate's surface which is attached with the organic solvent.

9. A device for producing an FRP precursor, wherein the device is used in the method for producing the FRP precursor according to claim 3, the device comprising:
an attaching means to attach an organic solvent to both aggregate's surfaces, which are both surfaces of the aggregate, and
a film press-adhering means to obtain the FRP precursor wherein under a normal pressure, of both surfaces of one film of the pair of the films, one aggregate-side film surface, which is a surface in an aggregate side thereof, is press-adhered to one surface of the both aggregate's surfaces which are attached with the organic solvent, and of both surfaces of another film of the pair of the films, an another aggregate-side film surface, which is a surface in an aggregate side thereof, is press-adhered to another surface of the both aggregate's surfaces which are attached with the organic solvent.
